(19) United States
(12) Patent Application Publication
(10) Pub. No.: US 2009/0128855 A1
(43) Pub. Date: May 21, 2009

(54) Method and apparatus printing e-mail

(75) Inventor: Byoung-yue Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/318,810

(22) Filed: Jan. 8, 2009

Related U.S. Application Data
(63) Continuation of application No. 10/361,646, filed on Feb. 11, 2003, now abandoned.

(30) Foreign Application Priority Data
Apr. 3, 2002 (KR) 2002-18224

(51) Int. Cl. G06F 3/12

(52) U.S. Cl. 358/1.15

(57) ABSTRACT

An e-mail printing method and its apparatus print an e-mail directly received from an e-mail sender. A printing apparatus is designated as/assigned a domain name, thereby providing a print destination. The print-destination domain name is included in the e-mail by the e-mail sender and the e-mail is transferred to the e-mail printing apparatus as designated by the e-mail sender using the print-destination domain name. Accordingly, a receiving mail server is bypassed, allowing quick/direct printing of the e-mail in real time, and eliminating an e-mail printing failure caused by malfunctioning of the receiving mail server.

### CROSS-REFERENCE TO RELATED APPLICATIONS

This application claims the benefit of Korean Application No. 2002-18224 filed Apr. 3, 2002, in the Korean Intellectual Property Office, and U.S. patent application Ser. No. 10/361,646, filed Feb. 11, 2003 in the U.S. Patent and Trademark Office, disclosures of which are incorporated herein by reference.

### BACKGROUND OF THE INVENTION

1. Field of the Invention

The present invention relates to the field of e-mails, and more particularly, to a method and apparatus printing e-mails.

2. Description of the Related Art

E-mails written by a sender to a recipient using OUTLOOK EXPRESS or other web mail service programs are stored in a recipient account in a receiving mail server (not shown) via a sending mail server (not shown). A conventional e-mail printing apparatus, for example, an e-mail printer, retrieves a desired recipient e-mail from the receiving mail server using pre-set user (i.e., recipient) information, such as, the address of the receiving mail server, user identification (ID), and user password. For example, an e-mail printer is connected to a receiving mail server using the address of the receiving mail server. The e-mail printer accesses the user account in the receiving mail server using user identification and user password, searches the e-mails in the accessed account, and receives and prints a desired e-mail. The e-mail printer periodically repeats such operations. In this case, the data transmission between an e-mail printer and a receiving mail server is performed using a post office protocol version 3 (POP3). More particularly, an e-mail printer executing a POP 3 server differs from a typical printer to which print jobs, such as e-mails, are transmitted via a user command at a computer connected to the printer.

According to the conventional e-mail printing method and apparatus described above, to print a desired e-mail, e-mails sent by a sender are stored in a user (i.e., recipient) account in a receiving mail server, and the stored e-mails are searched at a predetermined time interval by the e-mail printer and then sent to the e-mail printer. Accordingly, the e-mail printer requires a lot of processing time to receive and print the desired e-mail. The e-mail printer cannot receive and print the desired e-mail if a POP3 server (not shown) existing in the receiving mail server malfunctions or errs. Also, in the event that the receiving mail server does not support the POP3 server, the e-mail printer using the POP3 server cannot access a corresponding account in the receiving mail server. Thus, the e-mail printer cannot retrieve a desired e-mail from the receiving mail server. In addition, as e-mail printers are replaced, changed or upgraded, receiving mail servers must be changed or a new driving environment of the newly installed e-mail printer must be installed.

### SUMMARY OF THE INVENTION

The present invention provides an e-mail printing method printing an e-mail received from an e-mail sender in real time.

Further, the present invention provides an e-mail printing apparatus printing an e-mail transferred from an e-mail sender in real time.

Additional aspects and advantages of the invention will be set forth in part in the description which follows and, in part, will be obvious from the description, or may be learned by practice of the invention.

The present invention can be achieved according to an e-mail printing method performed in at least one e-mail printing apparatus printing an e-mail transferred from an e-mail sender. The printing method comprises directly receiving an e-mail from an e-mail sender, and printing the received e-mail. According to an aspect of the present invention, the e-mail is transferred to an e-mail printing apparatus designated by the e-mail sender.

According to another aspect of the present invention, there is provided at least one e-mail printing apparatus printing an e-mail received from an e-mail sender. In the e-mail printing apparatus, a mail receiving unit directly receives an e-mail from an e-mail sender and outputs the received e-mail. A printing unit in the e-mail printing apparatus prints the e-mail received from the mail receiving unit. According to an aspect of the present invention, the e-mail is transferred to an e-mail printing apparatus designated by the e-mail sender.

### BRIEF DESCRIPTION OF THE DRAWINGS

The advantages of the present invention will become more apparent by describing in detail preferred embodiments thereof with reference to the attached drawings in which:

FIG. 1 is a flowchart of printing an e-mail according to a first embodiment of the present invention;

FIG. 2 is a flowchart of printing an e-mail according to a second embodiment of the present invention;

FIG. 3 is a block diagram of an e-mail printing apparatus performing the e-mail printing method shown in FIG. 1;

FIG. 4 is a block diagram of an e-mail printing apparatus performing the e-mail printing method shown in FIG. 2; and

FIG. 5 is a block diagram of an example system using the e-mail printing apparatus of FIG. 3 or 4.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below to explain the present invention by referring to the figures.

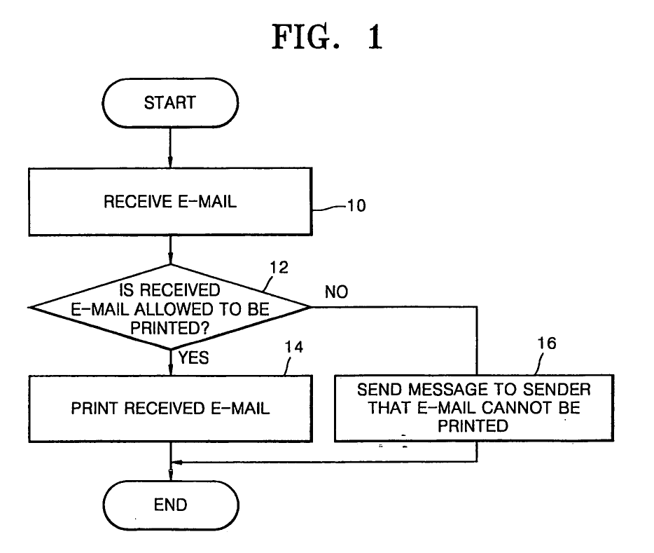

Referring to FIG. 1, an e-mail printing method according to the present invention comprises, at operation 10, receiving an e-mail and, at operations 12, 14 and 16, printing the e-mail according to whether the e-mail is allowed to be printed. The e-mail printing method of the present invention is performed in at least one e-mail printing apparatus printing an e-mail sent by a sender (i.e., an e-mail sender). More particularly, the e-mail is transferred to an e-mail printing apparatus designated by the sender from among at least one e-mail printing apparatus.

In FIG. 1, at operation 10, first, an e-mail transmitted from a sender is received. At operation 14, the received e-mail is printed. Further, at operation 12, it is determined whether the received e-mail is allowed to be printed. Operation 12, which determines whether the received e-mail is allowed to be printed, can be performed by checking whether an account for the received e-mail is a printing-allowed account.

If, at operation 12, it is determined that the received e-mail is allowed to be printed, in other words, if it is determined that the account for the received e-mail is a printing-allowed account, at operation 14, the received e-mail is printed. On the other hand, if, at operation 12, it is determined that the received e-mail is not allowed to be printed, in other words, if it is determined that the account for the received e-mail is not a printing-allowed account, at operation 16, a message informing that an e-mail cannot be printed is provided to the sender.

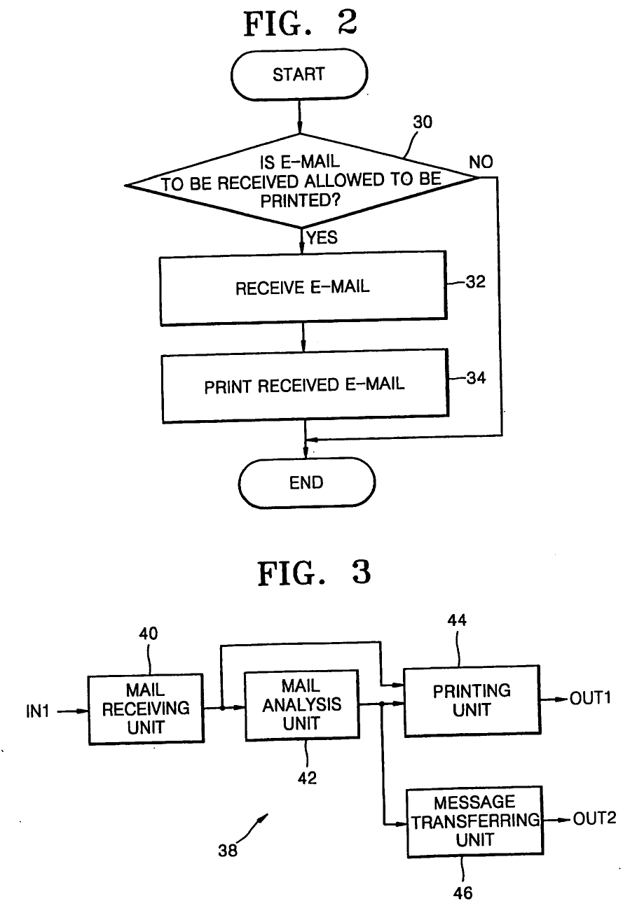

FIG. 2 is a flowchart of printing an e-mail according to a second embodiment of the present invention. In FIG. 2, the e-mail printing method comprises operations 30 and 32 receiving an e-mail depending on whether the e-mail is allowed to be printed and operation 34 printing the received e-mail. Referring to FIG. 2, at operation 30, it is determined whether an e-mail to be received is allowed to be printed. The determination at operation 30 can be made by receiving an account for the e-mail to be received before receiving the text of the e-mail and by checking that the received account is a printing-allowed account. Therefore, at operation 30, initially account information is received, and depending on the received account information, a corresponding e-mail is received.

If, at operation 30, it is determined that the e-mail to be received is not allowed to be printed, that is, if it is determined that the account for the e-mail to be received is not a printing-allowed account, e-mail printing stops (i.e., the receipt of the e-mail is refused, and, hence the e-mail is not received). On the other hand, if, at operation 30, it is determined that the e-mail to be received is allowed to be printed, that is, if it is determined that the account for the e-mail to be received is a printing-allowed account, at operation 32, the e-mail is received. At operation 34, the received e-mail is printed.

Typically, for example, an e-mail written by an e-mail sender (e.g., a sending-user at a computer) is transmitted to the e-mail's corresponding e-mail printing apparatus via a sending mail server (not shown), rather than via a receiving mail server. In this case, the sender includes in an e-mail a domain name identifying an e-mail printing apparatus to receive the e-mail and transfers the e-mail including the domain name to a sending mail server (not shown). The sending mail server transfers the e-mail to the e-mail printing apparatus identified with the domain name included in the e-mail. Accordingly, an e-mail can be transferred to an e-mail printing apparatus designated by a sender from among at least one e-mail printing apparatus.

According to an aspect of the present invention, transceiving of e-mails between a sender and an e-mail printing apparatus can be performed using a simple mail transfer protocol (SMTP). According to another aspect of the present invention, in FIG. 1 operations 12 and 16 may be omitted, such that an e-mail received at operation 10, is printed at operation 14. Likewise, in the e-mail printing method of FIG. 2 operation 30 may be omitted. In this case, an e-mail received at operation 32, is printed at operation 34.

According to an aspect of the present invention with respect to operation 14 of FIG. 1 or operation 34 of FIG. 2, a portion to be printed is extracted from the received e-mail and then the extracted portion is printed. However, according to another aspect of the present invention with respect to operation 14 of FIG. 1 or operation 34 of FIG. 2, the whole received e-mail can be printed immediately.

Hereinafter, the structure and operation of an e-mail printing apparatus that performs the aforementioned e-mail printing methods of FIG. 1 and FIG. 2 will be described with reference to the accompanying drawings. FIG. 3 is a block diagram of an e-mail printing apparatus (system) 38 embodying the e-mail printing process shown in FIG. 1. The printing apparatus 38 comprises a mail receiving unit 40, a mail analysis unit 42, a printing unit 44, and a message transferring unit 46. The mail receiving unit 40 performing operation 10 of FIG. 1, receives an e-mail through a first input port IN1 and outputs the received e-mail to the mail analysis unit 42 and the printing unit 44. The printing unit 44 performing operation 14, prints the received e-mail input from the mail receiving unit 40. Here, according to an aspect of the present invention, the e-mail printing apparatus can further comprise the mail analysis unit 42 and the message transferring unit 46, to perform operations 12 and 16.

The mail analysis unit 42 performing operation 12 analyzes the received e-mail input from the mail receiving unit 40, determines whether the received e-mail is allowed to be printed based upon the analysis, and outputs a determination result as a first control signal to the printing unit 44. More specifically, the mail analysis unit 42 extracts account information included in the received e-mail input from the mail receiving unit 40, and generates the first control signal depending on whether the extracted account information indicates a printing-allowed account. In this case, the printing unit 44 prints the e-mail in response to the first control signal input from the mail analysis unit 42 and outputs the printing result via an output port OUT1.

More particularly, if the printing unit 44 recognizes from the input first control signal that the e-mail is allowed to be printed, the printing unit 44 prints the e-mail. On the other hand, if the printing unit 44 recognizes from the input first control signal that the e-mail is not allowed to be printed, it does not print the e-mail. The message transferring unit 46 performing operation 16 transfers to the sender (e.g., a sending-user computer, a sending mail server) a message indicating that the e-mail cannot be printed, via an output port OUT2 in response to the first control signal input from the mail analysis unit 42. In other words, if the message transferring unit 46 recognizes from the input first control signal that the e-mail is allowed to be printed, it does not transfer to the sender the message informing that the e-mail cannot be printed via the output port OUT2. However, if the message transferring unit 46 recognizes from the input first control signal that the e-mail is not allowed to be printed, it transfers to the sender the message informing that the e-mail cannot be printed via the output port OUT2.

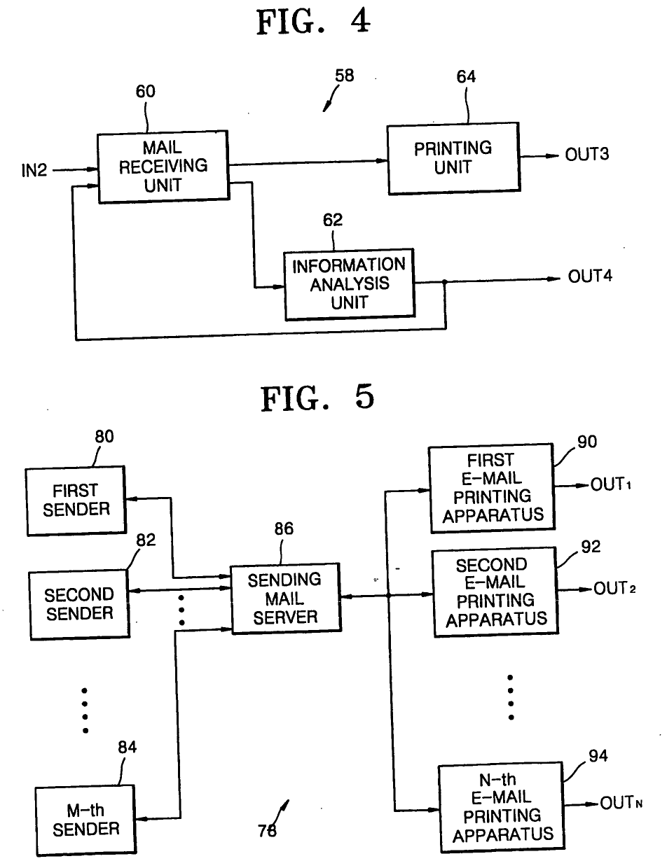

FIG. 4 is a block diagram of an e-mail printing apparatus (system) 58 embodying the e-mail printing process shown in FIG. 2. The e-mail printing apparatus 58 comprises a mail receiving unit 60, an information analysis unit 62 and a printing unit 64. The mail receiving unit 60 performing operation 32 of FIG. 2 receives an e-mail via a second input port IN2 and outputs the received e-mail to the printing unit 64. The printing unit 64 performing operation 34 prints the received e-mail input from the mail receiving unit 60 and outputs the printing result through an output port OUT3. Here, an e-mail printing apparatus according to an aspect of the present invention can further comprise the information analysis unit 62 performing operation 30.

The information analysis unit 62 performing operation 30 analyzes information about an e-mail to be received through the second input port IN2, determines whether the e-mail to be received is allowed to be printed based upon the analysis, and outputs a result of the determination as a second control signal to the mail receiving unit 60. The information analysis unit 62 generates the second control signal depending on whether an account for the e-mail to be received is a printing-allowed account.

Typically, the mail receiving unit 60 receives e-mail information, such as, an account, from a sender (e.g., a sending-user computer, a sending mail server) via the input port IN2 and outputs the received e-mail information to the information analysis unit 62. The mail receiving unit 60 can receive or cannot receive an e-mail from a sender through the second input port IN2 in response to the second control signal input from the information analysis unit 62. That is, if the mail receiving unit 60 recognizes from the input second control signal that the e-mail to be received is not allowed to be printed, it does not receive the e-mail through the input port IN2. On the other hand, if the mail receiving unit 60 recognizes from the input second control signal that the e-mail to be received is allowed to be printed, it receives the e-mail via the input port IN2. Further, the sender can also recognize that the e-mail to be received by the mail receiving unit 60 can be printed or cannot be printed, based on the second control signal received from the information analysis unit 62 via an output port OUT4. Therefore, typically, the mail receiving unit 60 only plays the role of receiving an e-mail sent by a sender, and the mail receiving unit 60 does not request the sender to send an e-mail. Consequently, the sender sends the e-mail regardless of a state of the second control signal, and the mail receiving unit 60 either receives (accepts) or does not receive (rejects) the sent e-mail in response to the input second control signal, which is output from the information analysis unit 62 to the mail receiving unit 60 based upon analysis of the received e-mail information. More particularly, if the mail receiving unit 60 recognizes from the input second control signal that the e-mail to be received is not allowed to be printed, the mail receiving unit 60 does not receive the e-mail through the input port IN2 but does not request the sender not to send the e-mail. Conversely, if the mail receiving unit 60 recognizes from the input second control signal that the e-mail to be received is allowed to be printed, the mail receiving unit 60 receives the e-mail through the input port IN2.

According to an aspect of the present invention, the printing unit 44 of FIG. 3 or the printing unit 64 of FIG. 4 can immediately print the whole received e-mail input from the mail receiving unit 40 or 60, respectively, or extract a necessary/desired part from the whole e-mail and then print only the extracted part. According to an aspect of the present invention, the mail receiving unit 40 of FIG. 3 or the mail receiving unit 60 of FIG. 4 can receive an e-mail, via the input port IN1 or IN2 from the Internet or a network, such as a local area network (LAN), from a sender directly or from a sender via a sending mail server (not shown).

FIG. 5 is a block diagram of an example system 78 using the e-mail printing apparatus of FIG. 3 or 4. The system 78 comprises first, second, . . . , and M-th senders (i.e., e-mail senders) 80, 82, . . . , and 84, a sending mail server 86, and first, second, . . . , and N-th e-mail printing apparatuses 90, 92, . . . , and 94, typically, all in communication with each other via a network.

The sending mail server 86 of FIG. 5 receives an e-mail transmitted and written by the first, second, . . . or M-th sender 80, 82, . . . or 84 and temporarily stores the received e-mail. At this time, the sending mail server 86 analyzes the received e-mail to determine an e-mail printing apparatus to which the e-mail is to be transferred. That is, the sending mail server 86 extracts a domain name from the e-mail, checks the extracted domain name to verify which e-mail printing apparatus the e-mail belongs to from among the first, second, . . . , and N-th e-mail printing apparatuses 90, 92, . . . , and 94, thereby determining an e-mail printing apparatus to which the e-mail is transferred.

Each first, second, . . . , and N-th e-mail printing apparatus 90, 92, . . . , and 94 has an individual domain name. The individual domain names allocated to the first, second, . . . and N-th e-mail printing apparatuses 90, 92, . . . , and 94, respectively, can be, for example, ‘mail1.printer.net’, ‘mail2.printer.net’, . . . and mailN.printer.net’. In this case, if the first, second, . . . , or M-th sender 80, 82, . . . , or 84 has written a domain name ‘mail1.printer.net’ in the ‘to’ section (i.e., destination or target address) of an e-mail, the sending mail server 86 transfers the e-mail with the domain name ‘mail1.printer.net’ to the first e-mail printing apparatus 90. That is, the sending mail server 86 transfers the checked e-mail to a determined e-mail printing apparatus from among the first, second, . . . , and N-th e-mail printing apparatuses 90, 92, . . . , and 94, using, for example, the SMTP.

If each first, second, . . . , and N-th e-mail printing apparatus 90, 92, . . . , and 94 of FIG. 5 is implemented according to the e-mail printing apparatus of FIG. 3, a result of printing performed by the printing unit 44 is output via a first, second, . . . , or N-th output port OUT1, OUT2, . . . , or OUTN. Also, a message output from the message transferring unit 46 can be transferred to the first, second, . . . , or M-th sender 80, 82, . . . , or 84 via the sending mail server 86.

On the other hand, if each first, second, . . . , and N-th e-mail printing apparatus 90, 92, . . . and 94 of FIG. 5 is implemented by the e-mail printing apparatus of FIG. 4, a result of printing performed by the printing unit 64 is output via the first, second, . . . , or N-th output port OUT1, OUT2, . . . , or OUTN. The second control signal output from the information analysis unit 62 is output to the sending mail server 86. If the sending mail server 86 recognizes from the received second control signal that an e-mail is not allowed to be printed, the sending mail server produces a message indicating that the e-mail is not allowed to be printed, and outputs the produced message to the first, second, . . . , or M-th sender 80, 82, . . . , or 84, which sent the e-mail. Further, typically, the mail receiving unit 60 sends to a sender a reason that an e-mail cannot be received by the e-mail printer 58, and a transmit path, through a SMTP Delivery Status Notification (DSN) message. Some example e-mail non-receipt reasons are that the receiving account is not a printing-allowed account, that some kind of error has been generated in the e-mail printer 58, that the e-mail printer 58 is busy, or that the format of the e-mail is invalid. Because SMTP is a fundamental concept in e-mail communication, detail description thereof is omitted.

As described above, in the e-mail printing method and apparatus according to the present invention as compared to a conventional e-mail printing method and apparatus requiring a receiving mail server, a printing apparatus can directly receive and print an e-mail from a sending mail server without the help of a receiving mail server. Thus, e-mails can be printed quickly in real time, and an e-mail printing failure caused by malfunctioning of a receiving mail server can be eliminated. Also, there is no need to perform operations between an e-mail printer and a receiving mail server to retrieve e-mails using a retrieving protocol, such as POP3, before printing an e-mail. In contrast, only a mail transfer communication protocol, such as SMTP, can be used to directly transmit an e-mail to an e-mail printing apparatus, reducing processing in printing an e-mail. In addition, a driving unit driving an e-mail printing apparatus, for example, a printer driver, is not required to be newly-installed or modified in a receiving mail server interfaced with a new/different e-mail printing apparatus, and instead, only the utilization of domain names enables a desired e-mail printing apparatus to perform e-mail printing. Therefore, the present invention simplifies the e-mail printing structure/process.

An e-mail printing method and a print apparatus implementing the e-mail print method, prints an e-mail directly received from an e-mail sender, which can be a sending-user computer or a sending mail server. The present invention designates/assigns a domain name to a printing apparatus, thereby providing a print destination. The print-destination domain name is included in an e-mail by the e-mail sender and the e-mail is directly transferred (i.e., without using a receiving mail server of a recipient) to the e-mail printing apparatus using the print-destination domain name. Accordingly, the e-mail printing process of the present invention bypasses receiving e-mail servers, allowing quick/direct or automatic printing of e-mails in real time, and eliminating e-mail printing failures caused by malfunctioning of the receiving e-mail servers. Also, bypassing a receiving e-mail server substantially simplifies and speeds the e-mail printing process by an e-mail printing apparatus. Further, although in the above example embodiment, a print-destination domain name is included in an e-mail as a destination address (i.e., in the ‘to’ section of an e-mail), the present invention is not limited to such configuration, and the print-destination domain name can be included, for example, in the ‘to’ section of an e-mail in addition to a user domain name (i.e., e-mail address) or included in another part of the e-mail to allow a sender to directly send the e-mail to the recipient e-mail printing apparatus. The processes of the present invention as embodied in the systems 38, 58 and 78 are implemented in computing hardware and/or software.

Although the preferred embodiments of the present invention have been described, it will be understood by those skilled in the art that the present invention should not be limited to the described preferred embodiments, but various changes and modifications can be made within the spirit and the scope of the present invention, which is defined in the claims and their equivalents.

What is claimed is:

1. A printing apparatus capable of receiving and printing e-mails, the printing apparatus comprising:
an e-mail receiver configured to receive e-mails addressed to a defined address identifying the printing apparatus;
a storage unit configured to store the e-mails received by the e-mail receiver; and
a printing unit configured to print an e-mail stored in the storage unit.

2. The printing apparatus of claim 1, further comprising:
a message generator configured to generate and send a message to a sender informing that the corresponding received e-mail cannot be printed.

3. The printing apparatus of claim 1, further comprising:
a message generator configured to generate and send a message to a sender that an e-mail could not be received by the e-mail receiver relating to a communication error.

4. The printing apparatus of claim 1, further comprising:
a mail analysis unit configured to analyze an e-mail received by the e-mail receiver and determine whether the received e-mail is allowed to be printed based on account information associated with the received email.

5. The printing apparatus of claim 1, wherein the defined address identifying the printing apparatus comprises a destination address of the printing apparatus on a network.

6. The printing apparatus of claim 1, wherein the e-mails are transmitted directly from an e-mail sender to the printing apparatus without assistance of a receiving mail server.

7. The printing apparatus of claim 1, wherein the destination address identifying the printing apparatus comprises a domain name of the printing apparatus.

8. The printing apparatus of claim 7, wherein the domain name comprises a print destination domain name of the printing apparatus.

9. The printing apparatus of claim 1, wherein the destination address identifying the printing apparatus comprises an e-mail address of the printing apparatus.

10. The printing apparatus of claim 1, wherein the e-mails are received by the e-mail receiver using a simple mail transfer protocol (SMTP).

11. The printing apparatus of claim 1, wherein the e-mail receiver is implemented in computing hardware and/or software of the printing apparatus.

12. The printing apparatus of claim 1, further comprising:
an extracting unit configured to extract a portion to be printed from the received email and to request printing of the extract portion of the received email.

13. The printing apparatus of claim 1, wherein at least one of the received emails comprises a text message and an image data as an attachment.
